(19) United States
(12) Patent Application Publication
(10) Pub. No.: US 2015/0284502 A1
(43) Pub. Date: Oct. 8, 2015

(54) EPOXY RESINS CROSSLINKABLE AT ROOM TEMPERATURE

(71) Applicants: UNIVERSITE MONTPELLIER, Montpellier (FR); CENTRE NATIONAL DE LA RECHERCHE SCIENTIFIQUE, Paris (FR)

(72) Inventors: Vincent LaPinte, Castries (FR); Amelia Ulloa Habas, Montpellier (FR); Olivia Giani, Le Cres (FR); Jean-Pierre Habas, Montpellier (FR)

(21) Appl. No.: 14/436,971

(22) PCT Filed: Oct. 24, 2013
(86) PCT No.: PCT/EP2013/072285

§ 371 Date: Jun. 1, 2015

(30) Foreign Application Priority Data
Oct. 25, 2012 (FR) 1260197

(51) Int. Cl. C08G 59/02

(52) U.S. Cl. CPC C08G 59/02

(57) ABSTRACT

An epoxy resin is provided that is cross-linkable at room temperature, including the product of a reaction of a mixture including at least one epoxy function carrier derivative, chosen from the group consisting of non-polymeric, non-bio-sourced reagents and carriers of at least 3 epoxy end functions and biosourced, epoxidized lipidic derivatives, and at least one crosslinking agent, the ratio between the number of epoxy functions being kept constant independently of the composition of the mixture, the method for manufacturing same, and the use thereof in composite parts for the mechanical engineering or for building construction and in structural parts.

A subject of the present invention is novel epoxide resins with improved reactivity, the process for the formulation and manufacture thereof and the uses thereof.

Currently, epoxide resins are very widely used whether in the context of industrial or domestic applications. They are for example available as structural adhesives, paint bases with a high mechanical strength or also as matrices for composite materials in combination with reinforcements of different types (carbon-containing, mineral, vegetable) and in very diverse forms (particles, long or short fibres). The vast majority of these resins are petrochemical derivatives. Thus, the predicted exhaustion of this fossil resource and also the health problems presented by these resins which are often based on bisphenol A (DGEBA) have motivated research aimed at exploring the development of formulations from other resources.

A promising lead lies, in particular, in the use of vegetable oils having a high level of unsaturations and which can, by simple chemical treatment, be converted to oxirane units or epoxy groups. The vegetable oil thus functionalized (i.e. epoxidized) can then react with the same classes of hardeners as the petrochemical epoxy resins namely polyamines, acid anhydrides, diacids, mercaptans or also alcohols. However, their rate of reaction is undeniably slower than that found with the petrochemical resins (DGEBA, DGEBF or novolacs) for the same type of hardener.

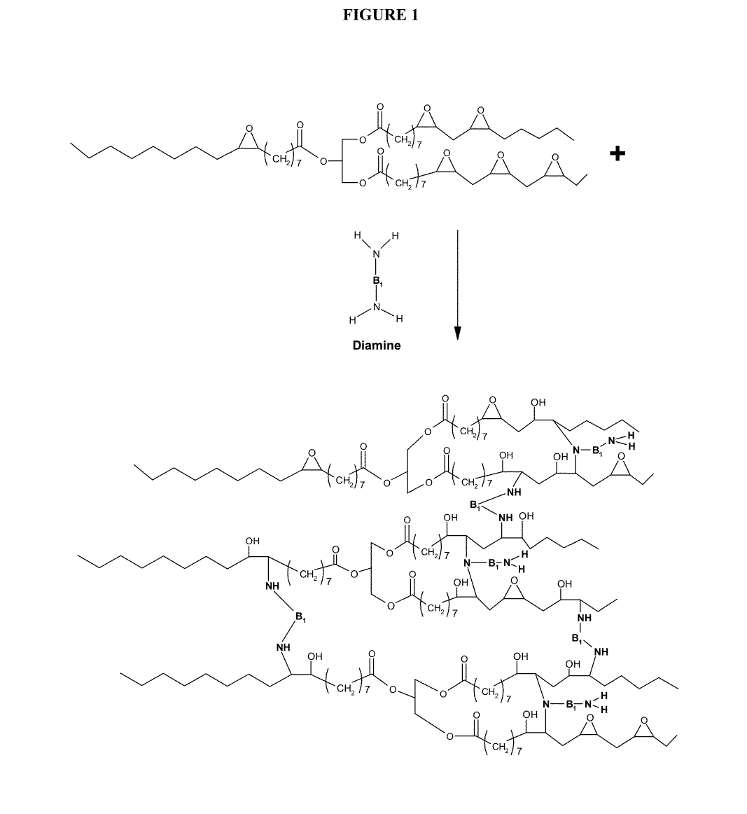

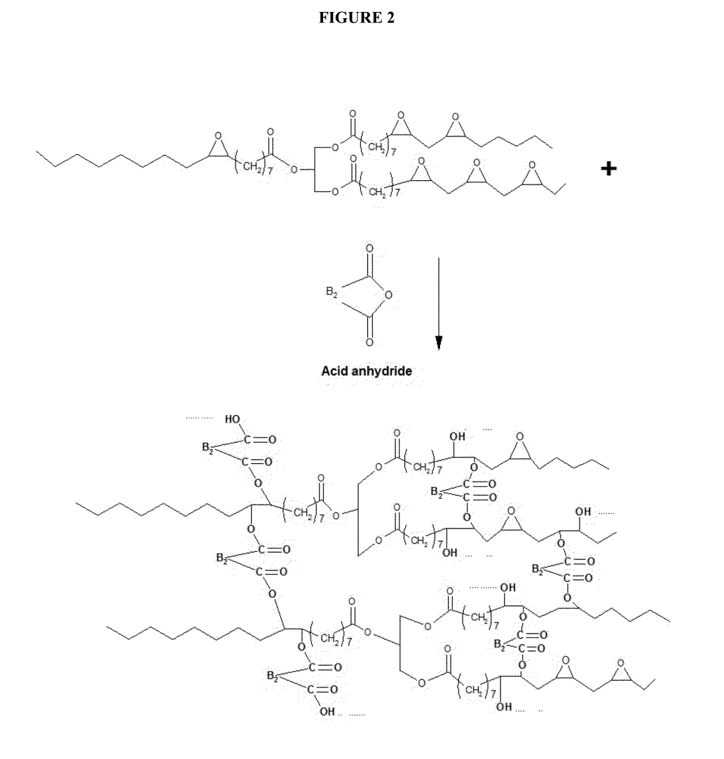

This decline in reactivity is a direct consequence of the central position of the oxirane groups on the fatty chains which, for that reason, cannot present the same accessibility vis-à-vis the reactive units of the hardener as that offered by the abovementioned petrochemical resins for which the epoxy groups are ideally situated at the end of the (macro)molecular members. FIG. 1 shows the standard reaction diagram between an epoxidized oil and a diamine. As for FIG. 2 it describes the standard reaction diagram between an epoxidized oil and an acid anhydride.

Moreover, taking into consideration one and the same hardener i.e. type, unchanged functionality) and for a constant “epoxy units”/“hardener reactive units” ratio, the aliphatic structure of the epoxidized vegetable oils for its part induces a net reduction in the mechanical performance of the cross-linked material always considering the petroleum-sourced matrices listed previously (DGEBA, DGEBF and novolacs etc.) as the comparison element. In fact, these latter comprise numerous aromatic rings allowing a mechanical rigidity and a higher glass transition temperature.

Thus, Tan S. G. et al. (Polymer-Plastics Technology and Engineering, (2010) 49, 1581-1590) describe a thermosetting resin formulated by the reaction of epoxidized soya oil with a methylhexahydrophthalic anhydride (MHHPA) as hardener and in the presence of tetraethylammonium bromide as catalyst. The mixture is put in a mould then cross-linked at 140° C. Polymerization is only complete at the end of 3 hours.

Gerbase A. E. et al. (J. Am. Oil Chem. Soc., (2002), 79, 797-802) report the mechanical properties of epoxide resins based on soya oil obtained by the reaction of said soya oil with different cyclic acid anhydrides in the presence of tertiary amines. The mixtures are generally heated at 150° C. for 14 hours.

Boquillon N. et al. (Polymer, (2000), 41, 8603-8613) describe the properties of epoxide resins obtained by the reaction of epoxidized linseed oil with different hardeners of anhydride type in the presence of different catalysts. The treatment cycle is 15 hours at 150° C. then 1 hour at 170° C. The formulation of the linseed oil/tetrahydrophthalic anhydride (THPA)/2-methylimidazole mixture leads to resins having the best mechanical properties after cross-linking.

Chrysanthos M. et al. (Polymer, (2011), 52, 3611-3620) describe biosourced resins derived from diglycidyl ether of epoxidized isosorbide of vegetable origin as a replacement for DGEBA. The hardener used is petro-sourced isophorone diamine and the treatment cycle is 1 hour at 80° C. followed by 2 hours at 180° C.

International application WO 2008/147473 relates to biosourced polymers obtained by the reaction of a resin based on glycidyl ethers of anhydrosugars of vegetable origin, for example isosorbide, isomannide or isoiodide with a hardener of biosourced or non-biosourced origin. When the cross-linking step is carried out at temperatures comprised between 100° C. and 150° C., it takes about 3 hours; when it is carried out at very high temperatures, of the order of 250° C., it takes 30 minutes. Tests of cross-linking at ambient temperature show that it takes 24 hours in order to obtain complete cross-linking.

International application WO 2010/136725 relates to a process for the preparation of thermosetting epoxide resins formulated from epoxidized natural phenolic compounds and a hardener. These phenolic compounds originate from biomass in particular from plants, algae, fruits, or trees. The hardener is a compound bearing primary or secondary amine functions such as for example cycloaliphatic compounds, in particular Epamine PC 19. These resins are cross-linked at ambient temperature over periods of several hours.

Liu et al. (Journal of Agricultural and Food Chemistry (2006), 54, 2134-2137), describe epoxy formulations produced by mixing epoxidized soya oil and 1,1,1-tris(4-hydroxyphenyl)ethane triglycidylether (THPE-GE) with a ratio by weight of 1:0.33 in the presence of a polyamine, triethylene tetramine (TETA), used as cross-linking agent. THPE-GE is dosed considering the ratio of the number of NH groups to the number of epoxy functions of the single epoxidized lipid derivative as constant; the cross-linking times at 100° C. are very long (approximately 24 hours) and their mechanical properties are not excellent.

Application GB 1 401 677 describes epoxide resins comprising the product of the reaction of a mixture comprising a non-biosourced non-polymer reagent and bearing at least 3 epoxy end functions and at least one cross-linking agent of the family of the amines or the anhydrides, the ratio between the number of reactive functions of the cross-linking agent and the number of epoxy functions being very much less than 1. GB 1,401,677 also describes epoxide resins for which the epoxide functions are provided both by a non-biosourced non-polymer reagent bearing at least 3 epoxy end functions and by a diglycidyl ether of bisphenol A. These resins are cross-linked at temperatures greater than ambient temperature.

Petro-sourced resins capable of being cross-linked at ambient temperature have also been described but the cross-linking times are very long, of the order of several days, and the anhydride groups/epoxy groups ratio is still less than 1. Thus, U.S. Pat. No. 6,468,659 describes resins comprising the product of the reaction of two components capable of being cross-linked at ambient temperature, the first component being a derivative bearing epoxy groups, in particular 4,4′-methylenebis(N,N-diglycidylaniline) and O,N,N-triglycidyl-4-aminophenol and the second component being a cyclic anhydride; international application WO 85/05215 describes epoxide resins comprising in particular the product of the reaction of a mixture comprising a polyglycidyl aromatic amine which can be diglycidylaniline and a polycarboxylic acid anhydride which can be methyl tetrahydrophthalic anhydride.

Biosourced resins have also been described. Thus, U.S. Pat. No. 2,949,441 describes a process for the preparation of resin from epoxidized vegetable oils, said process comprising the reaction of these compounds with at least 0.8 equivalents of a polycarboxylic anhydride in the presence of at least 10% of amines, one equivalent being defined as being the quantity necessary to provide one anhydride group per epoxy group. Due to the fact of the decline in the reactivity and in the final mechanical performances linked to the low reactivity of the systems bearing “internal” epoxy functions in comparison to that of the petrochemical epoxy prepolymers bearing reactive end functions, it is necessary, in order to improve the reactivity of the lipid derivatives, to use tertiary amines as catalysts in the presence of a hardener of anhydride type. Nevertheless, under these conditions, the reactions are effectively accelerated but the cross-linking temperatures remain much greater than ambient temperature (T>100° C.).

Also, it is necessary to improve, in terms of time and temperature, the cross-linking of epoxide resins based on vegetable oils.

The purpose of the present invention is therefore to propose a wide range of resins based on natural oils and having a very high reactivity and therefore capable of cross-linking at ambient temperature and over short polymerization times while offering enhanced mechanical properties.

Another objective of the present invention is to be able to control the cross-linking of these resins in terms of time and temperature.

A further objective is to be able to adjust the final properties of these resins with regard to a targeted application.

These objectives are achieved by the present invention which provides resins originating from natural oils formulated in the presence of a co-reactant of non-biosourced origin.

The inventors have shown during their research, that the defects inherent in the epoxidized oils must be counterbalanced by the addition of petro-sourced epoxidized co-reactants displaying the following characteristics:
an arrangement of the epoxy sites which is more favourable to the reaction with the hardener units,
a functionality greater than or equal to 3 in particular through
a branched structure in order to produce the three-dimensional network more rapidly (shorter gel time),
small molecular branches bearing oxirane units which will lead to a reduction in the average size of the unit cell of the molecular network with respect to the binary “oil-hardener” mixture and therefore lead to additional performances (increased mechanical rigidity, higher Tg),
if possible, a rigid central core of aromatic or cyclic type in order to reinforce the previous point.

Also during this work, the inventors have used petro-sourced epoxidized molecules capable of making oxirane units very accessible at the end of molecular segments of small size. These molecules have no repeat unit and cannot therefore be qualified as oligomers and even less as polymers. They are based on a structure comprising at least three branches of reduced size, each bearing an oxirane termination which is easily accessible to the reactive units of the hardener.

The addition of these small very reactive branched epoxide molecules to the oleaginous formulation, formed by the mixture of one or more epoxidized oils with one or more hardeners, reduces the gel time of said mixture while the glass transition temperature (Tg) of the final material is increased. In this case, these small branched epoxide molecules are called co-reactants. The extent of these two last developments is directly linked to the specific type of the co-reactant, its functionality and also its proportion in the reaction mixture.

The inventors have also shown that these epoxide molecules alone can react directly with one or more hardeners in the absence of epoxidized oil in order to produce a final material having useful properties.

Also a subject of the present invention is epoxide resins comprising the product of the reaction of a mixture comprising:
at least one non-biosourced non-polymer reagent bearing at least 3 epoxy end functions (CRₓ),
at least one biosourced epoxidized lipid derivative, and
at least one cross-linking agent,
   the ratio between the number of reactive functions of the cross-linking agent and the number of epoxy functions being kept constant independently of the constitution of the mixture, on the condition that:
CRₓ is not a compound having the following formula (a):

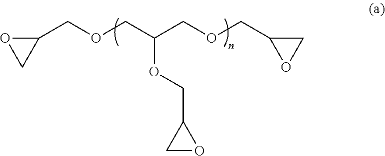

in which n is an integer comprised between 1 and 20.

The mixture which reacts with the cross-linking agent can comprise either only one or more non-biosourced non-polymer reagents bearing at least 3 epoxy end functions, (CRₓ), or, according to the invention, at least one non-biosourced non-polymer reagent bearing at least 3 epoxy end functions (CRₓ) and one or more biosourced epoxidized lipid derivatives. The mixture can never contain only biosourced epoxidized lipid derivatives as the source of epoxy functions. In all cases, the ratio between the number of reactive functions of the cross-linking agent and the number of epoxy functions is kept constant, whether the epoxy functions are provided only by one or more non-biosourced non-polymer reagents (CRₓ) or by a mixture of one or more non-biosourced non-polymer reagents (CRₓ) and biosourced epoxidized lipid derivatives.

In the resins according to the invention, the at least one non-biosourced non-polymer reagent bearing at least 3 epoxy end functions (CRₓ) is used in addition to or as a substitution for the epoxy groups of the epoxidized lipid derivative. When it is used in addition to or as a substitution for the epoxy groups of the epoxidized lipid derivative it is called, in this case, co-reactant.

The ratio

$$\frac{\begin{matrix}number of reactive groups \\ of the cross \text{-} linking agent in the mixture\end{matrix}}{Number of epoxy groups in the mixture}$$

is called Q,

said epoxy groups being borne either by the lipid derivative(s) and the at least one non-biosourced non-polymer reagent (CRₓ) or only by the non-biosourced non-polymer reagent (CRₓ) when it is used alone.

Within the meaning of the present invention, by “cross-linking agent” or “hardener” is meant a compound which reacts with the epoxide functions in order to allow the creation of a three-dimensional polymer network. Then it is called cross-linking.

Within the meaning of the present invention, by “epoxide resins”, or “epoxidized resins” or “epoxy resins” is meant the product of the reaction of an epoxidized compound with a cross-linking agent. Epoxidized resins are examples of thermosetting resins.

According to the invention, by “epoxidized compound” is meant a compound into which several epoxide groups are introduced. An epoxidized compound can also be called “epoxide” or “oxirane” or also “epoxy”.

By “epoxide function” or “epoxy group” or “oxirane function” or “oxirane group” is meant a cyclic function with three members having two carbons and an oxygen atom.

Within the meaning of the present invention, by “reactive chemical groups of the cross-linking agent, is meant any chemical group or function capable of reacting by establishing covalents bonds with the epoxy groups of the lipid derivatives or of the non-biosourced non-polymer reagent (CRₓ).

Within the meaning of the present invention, by non-biosourced reagent is meant a reagent not originating from biomass.

In an advantageous embodiment of the invention, the at least one CRₓ corresponds:

a. to the formula (Ia),

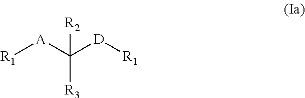

in which
A and D each represent independently of one another:
   a —(CₙH₂ₙ)— radical where n is comprised between 1 and 5, in particular a —CH₂— radical or
   an arylene radical, in particular a phenylene radical (—C₆H₄—), or
   a —(CH₂)ₗ—O—(CH₂)ₘ-[CH(CH₃)]ₚ—OR group where l and m, identical or different, are integers comprised between 1 and 5, therefore being able to equal, independently of one another, to 0, 1, 2, 3, 4 or 5, p is an integer comprised between 0 and 1, and R is the following group

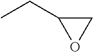

R₁ represents an —OR group, where R is as defined previously
R₂ and R₃ each represent independently of one another,
   either a hydrogen atom,
   or a linear or branched (C₁-C₅)alkyl group,
   or an —OR group, where R is as defined previously,
   or a —CH₂OR group, where R is as defined previously,
   or a —C₆H₄OR group, where R is as defined previously,
   or a linear or branched —O—(CH₂)ᵣ—[CH(CH₃)]ₛ—OR group, where r is an integer comprised between 1 and 5, therefore being able to be equal to 1, 2, 3, 4 or 5 and s is an integer comprised between 0 and 1 and R is as defined previously,
      on the condition that the compound of formula

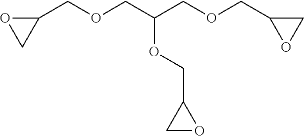 [SMILES: C(OCC1CO1)C(COCC1CO1)OCC1CO1]

is excluded,
or
b. to the formula (Ib)

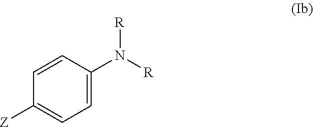

in which
Z represents
   either an OR group where R is as defined previously,
   or the following group

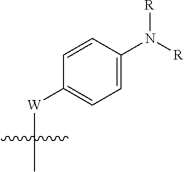

where W is selected from the group comprising the oxygen and sulphur atoms and the linear or branched —(CₙH₂ₙ)— radicals where n is comprised between 1 and 5, therefore being able to be equal to 1, 2, 3, 4 or 5 and —SO₂— and R is as defined previously

Within the meaning of the present invention, by radical —(CₙH₂ₙ)— is meant a divalent group derived from a carbon-containing chain comprising from 1 to 5 carbon atoms. By way of example, the —CH₂— (methylene radical), —CH₂CH₂— (ethylene radical), —CH(CH₃)—, —C(CH₃)₂—, —CH₂—CH(CH₃)—CH₂—C(CH₃)₂, —CH₂CH₂CH₂— (propylene radical), —CH₂CH₂C(CH₃)₂—(isopropylene radical), —CH₂CH₂CH₂CH₂— (butylene radical), —CH₂CH(CH₃)CH₂—CH₂C(CH₃)₂CH₂— (dimethylpropylene radical) and —CH₂CH₂CH₂CH₂CH₂-(pentylene radical) groups can be mentioned.

Within the meaning of the present invention, among the —(CH₂)ₗ—O—(CH₂)ₘ—[CH(CH₃)]ₚ—OR groups where l and m, identical or different, are integers comprised between 1 and 5, therefore being able to be equal, independently of one another, to 0, 1, 2, 3, 4 or 5, p is an integer comprised between 0 and 1, and R is as defined previously, the —CH₂—O—CH₂—CH(CH₃)—OR or also —CH₂—OR groups can be mentioned.

Within the meaning of the present invention, among the —O—(CH₂)ᵣ—[CH(CH₃)]ₛ—OR groups where r is an integer comprised between 1 and 5, therefore being able to be equal to 1, 2, 3, 4 or 5 and s is an integer comprised between 0 and 1 and R is as defined previously, the —O—CH₂—OR, —O—(CH₂)₂—OR, —O—(CH₂)₃—OR, —O—(CH₂)₄—OR, —O—(CH₂)₅—OR, —O—CH(CH₃)—OR, —O—CH₂—CH(CH₃)—OR groups can be mentioned.

By arylene group is meant a divalent group derived from an aryl group comprising from 6 to 10 carbon atoms. By way of example the —C₆H₄-(phenylene radical) and —C₁₀H₈— (naphthylene radical) radicals can be mentioned.

In an advantageous embodiment of the invention the at least one CRₓ corresponds to formula (Ia) in which:
A and D each represent a —CH₂— group, R₂ represents either a hydrogen atom, or a —CH₂OR group, —C₆H₄OR where R is as defined previously and
R₃ represents a methyl, ethyl, —CH₂OR or —O—CH₂—CH(CH₃)—OR group where R is as defined previously,
   on the condition that the compound of formula

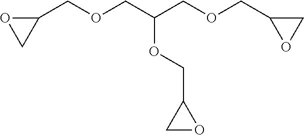 [SMILES: C(OCC1CO1)C(COCC1CO1)OCC1CO1]

is excluded.

In another advantageous embodiment of the invention the at least one CRₓ corresponds to formula (Ia) in which:
A and D each represent a —(C₆H₄)— group,
R₂ represents a hydrogen atom or a methyl group and
R₃ represents a —C₆H₄OR group where R is as defined previously.
By way of example of CRₓ of formula (Ia) the compound of formula (CR3)

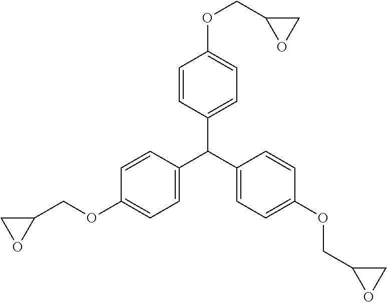 [SMILES: c1cc(C(c2ccc(OCC3CO3)cc2)c2ccc(OCC3CO3)cc2)ccc1OCC1CO1]

can in particular be mentioned.

In another advantageous embodiment of the invention the at least one CRₓ corresponds to formula (Ib) in which Z represents either an OR group where R is as defined previously, or the following group

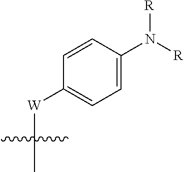

where W is a —CH₂— radical.

By way of example the compound of formula (CR1)

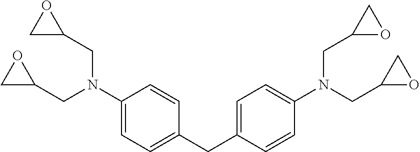 [SMILES: c1cc(N(CC2CO2)CC2CO2)ccc1Cc1ccc(N(CC2CO2)CC2CO2)cc1]

and the compound of formula CR2

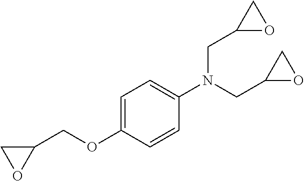 [SMILES: c1cc(N(CC2CO2)CC2CO2)ccc1OCC1CO1]

can in particular be mentioned.

These (CRₓ) molecules are qualified as reactive since they rely on the same reaction mechanism vis-à-vis the reactive units of the hardener as that described at the beginning for the single epoxy units borne by the fatty chains. In other words, they should not be confused with a simple catalyst even if only a single macromolecular network exists. In the presence of a fatty chain, the initial branched structure of the molecules of the co-reactant also contribute to the rapid three-dimensional growth of the polymer network. Then it is called a co-reactant. The reduced size of each branch, optionally in addition to a central aromatic hinge, guarantees a more rigid average network unit cell. This last point is the factor at the origin of the increase in the glass transition temperature of the cross-linked material and more generally to the enhancement of its mechanical properties. These reagents allow the modification of a large range of epoxide resins based on vegetable oil and capable of cross-linking at ambient temperature over short polymerization times while offering enhanced mechanical properties.

In an advantageous embodiment of the invention, the one or more biosourced epoxidized lipid derivatives are:
either extracts of a natural vegetable oil, in particular vernolia oil, in which they are present in the epoxidized form,
or obtained by epoxidation of lipids extracted from natural vegetable oils selected from the group comprising linseed oil, hemp oil, sunflower oil, colza oil, soya oil, olive oil, grapeseed oil, tung wood oil, cotton oil, maize oil, hazelnut oil, coconut oil, palm oil, castor oil, cashew nut oil and peanut oil and a mixture of the latter or animal oil extracts.

In fact a vegetable oil can be defined as a statistical product composed predominantly of triglycerides but also, to a lesser extent, of diglycerides and monoglycerides. The structure of the triglyceride units may be summarized as the grafting of three fatty acid esters onto one glycerol unit. The term unsaturated fatty chains is used to describe those bearing carbon-carbon double bonds (C═C). The presence of unsaturations in the fatty chains is particularly useful as the latter can be converted to oxirane units by use of peracids or hydrogen peroxide. This step is also denoted by the term epoxidation. Some examples of unsaturated fatty chains are presented in Table 1.

TABLE 1

| Fatty acid | Chemical formula |
|---|---|
| Palmitoleic acid | CH₃(CH₂)₅CH═CH(CH₂)₇COOH |
| Oleic acid | CH₃(CH₂)₇CH═CH(CH₂)₇COOH |
| Linoleic acid | CH₃(CH₂)₄CH═CH—CH₂—CH═CH(CH₂)₇COOH |
| Linolenic acid | CH₃—CH₂—CH═CH—CH₂—CH═CH—CH₂—CH═CH(CH₂)₇COOH |
| Eleostearic acid | CH₃—(CH₂)₃—CH═CH—CH═CH—CH═CH(CH₂)₇COOH |
| Ricinoleic acid | CH₃—(CH₂)₄CH—CH(OH)—CH₂—CH═CH(CH₂)₇COOH |

According to the invention, the at least one cross-linking agent is selected:
a. from the group comprising compounds bearing amine functions, said compounds when they are bearing primary amine functions being selected from the group comprising the diamines, polyamines and mixtures thereof or
b. from the group of the acid anhydrides or
c. from the group of the diacids and the polyacids or
d. from the group of the alcohols including the phenols or
e. from the group of the polymercaptans or
f. from the group comprising the mixtures of at least two agents chosen from those mentioned in a) to e).

Among the hardeners or cross-linking agents of diamine type there can be mentioned:
the aliphatic diamines of generic form H₂N—Ra—NH₂ where Ra is an aliphatic chain of non-biosourced origin such as ethylenediamine, hexamethylenediamine, bis(3-aminopropyl)amine and 1,10-decanediamine or of biosourced origin such as 1,4-butanediamine, 1,5-pentanediamine, 1,12-dodecanediamine and 1,18-octadecanediamine.
the cycloaliphatic diamines of generic form H₂N—Rb—NH₂ where Rb is basically an aliphatic cyclic unit such as isophorone diamine (IPDA).
the aromatic diamines of generic form H₂N-Rc-NH₂ where Rc is originally formed by an aromatic ring such as phenylenediamine in its ortho, meta, para forms, xylylenediamine in its ortho, meta, para forms, 2,5-diaminotoluene, 4,4′-diaminobisphenyl and 4,4′-diaminodiphenylmethane.
the polyamines such as diethylenetriamine, triethylenetetramine, tetraethylenepentamine, poly(oxypropylene)triamine or also the polyetheramines.

By way of example of acid anhydrides, the following molecules can be mentioned: succinic anhydride, maleic anhydride, dodecenylsuccinic anhydride, phthalic anhydride, hexahydrophthalic anhydride, methylhexahydrophthalic anhydride, methyl tetrahydrophthalic anhydride, methyl-endo-methylenetetrahydrophthalic anhydride.

By way of example of diacids the following molecules can be mentioned: heptanedioic acid HOOC—(CH₂)₅—COOH; phthalic acid; isophthalic acid; fumaric acid, maleic acid, terephthalic acid, succinic acid, itaconic acid, hexahydrophthalic acid, methyl hexahydrophthalic acid, tetrahydrophthalic acid, methyl tetrahydrophthalic acid, and pyromellitic acid.

By way of example of polymercaptans or polythiols, the following molecules can be mentioned: 1,2,5-trimercapto-4-thiapentane, 3,3-dimercaptomethyl-1,5-dimercapto-2,4-dithiapentane, 3-mercaptomethyl-1,5-dimercapto-2,4-dithiapentane, 3-mercaptomethylthio-1,7-dimercapto-2,6-dithiaheptane, 1,2,7-trimercapto-4,6-dithiaheptane, 3,6-dimercaptomethyl-1,9-dimercapto-2,5,8-trithianonane, 1,2,9-trimercapto-4.6,8-trithianonane, 3,7-dimercaptomethyl-1,9-dimercapto-2,5,8-trithianonane, 4,6-dimercaptomethyl-1,9-dimercapto-2,5,8-trithianonane, 3-mercaptomethyl-1,6-dimercapto-2,5-dithiahexane, 3-mercaptomethylthio-1,5-dimercapto-2-thiapentane, 1,1,2,2-tetrakis(mercapto methylthio)ethane, 1,1,3,3-tetrakis(mercaptomethylthio)propane, 1,4,8,11-tetramercapto-2,6,10-trithiaundecane, 1,4,9,12-tetramercapto-2,6,7,11-tetrathiadodecane, 2,3-dithia-1,4-butanedithiol, 2,3,5,6-tetrathia-1,7-heptanedithiol, 2,3,5.6,8,9-hexathia-1,10-decanedithiol

In another particular embodiment of the invention, when the at least one cross-linking agent is a compound bearing N—H groups, belonging to primary or secondary amine functions, the ratio Q_{NH}:

$${Q}_{N H} = \frac{number of N \text{-} H groups}{number of epoxy groups in the mixture borne either by the or the lipid derivatives and the at least one \text{-} biosourced non \text{-} polymer reagent or the non \text{-} biosourced non \text{-} polymer reagent when it is used alone}$$

is advantageously such that one N—H group corresponds to each epoxy group. This is equivalent to saying that the ratio of the number of N—H groups to the number of epoxy groups is equal to unity.

In another particular embodiment of the invention, when the at least one cross-linking agent is a compound bearing acid anhydride groups, the ratio Q_{anhydride}

$${Q}_{anhydride} = \frac{number of acid anhydride groups}{number of epoxy groups borne either by the lipid d eriv ative ( s ) and the at least one \text{-} biosourced non \text{-} polymer reagent or the non \text{-} biosourced non \text{-} polymer reagent when it is used alone}$$

is advantageously such that one acid anhydride group corresponds to each epoxy group. This is equivalent to saying that the ratio of the number of acid anhydride groups to the number of epoxy groups is equal to unity.

The ratio Q_{SH} for the cross-linking agents bearing SH groups or the ratio Q_{diacid} for the cross-linking agents of the family of diacids are calculated in the same way.

In the case where the ratio Q_{NH}, Q_{anhydride}, Q_{SH} or Q_{diacid} is different from 1, reaction between the epoxy compound and the cross-linking agent is still possible. A person skilled in the art will be able to define the optimum stoichiometry so as to obtain a material capable of satisfying the technical requirements of the intended application.

The epoxidized lipid derivative(s) represent from 0 to 99%, advantageously according to the invention from 1 to 99% in terms of number of epoxy functions, of the derivatives bearing an epoxy function and the CRₓ(s), from 100 to 1%, advantageously according to the invention from 99 to 1% in terms of the number of epoxy functions, of the derivatives bearing an epoxy function. Thus, in a 80-20 mixture, 80% of the epoxy functions are provided by one or more lipid derivatives and 20% by one or more CRₓ(s); in a 50-50 mixture, 50% of the epoxy functions are provided by one or more lipid derivatives and 50% by one or CRₓ(s); in a 20-80 mixture, 20% of the epoxy functions are provided by one or more lipid derivatives and 80% by one or more CRₓ(s).

The resins according to the invention may, moreover, contain additives that are usual in this field, for example diluents, solvents, pigments, fillers, plasticizers, antioxidants, stabilizers. These additives may or may not be biosourced.

A process for the formulation of epoxide resins comprises the mixture of:
at least one derivative bearing an epoxy function selected from the group constituted by the non-biosourced non-polymer reagents bearing at least 3 epoxy end functions (CRₓ) and the biosourced epoxidized lipid derivatives, and
at least one cross-linking agent,
   the ratio between the number of reactive functions of the cross-linking agent and the number of epoxy functions being kept constant independently of the constitution of the mixture, on the condition that:
said non-biosourced, non-polymer reagent is not a compound having the following formula (a):

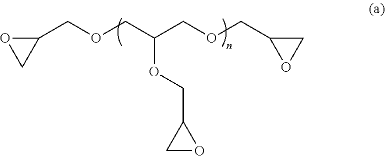

in which n is an integer comprised between 1 and 20 and
at least one non-biosourced, non-polymer reagent is always present in the mixture.

A subject of the present invention is also a process for the formulation of epoxide resins comprising the mixture of:
at least one non-biosourced non-polymer reagent bearing at least 3 epoxy end functions (CRₓ),
at least one biosourced epoxidized lipid derivative, and
at least one cross-linking agent,
   the ratio between the number of reactive functions of the cross-linking agent and the number of epoxy functions being kept constant independently of the constitution of the mixture, on the condition that:
said non-biosourced, non-polymer reagent is not compound having the following formula (a):

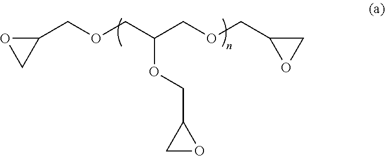

in which n is an integer comprised between 1 and 20

In an advantageous embodiment of the invention, the process comprises the following steps:
a. mixing one or more biosourced epoxidized lipid derivatives,
b. adding the at least one CRₓ then carrying out a mixing operation to obtain a homogeneous epoxy mixture,
c. adding the cross-linking agent to said mixture and then carrying out a further mixing operation,
d. then leaving the resin to react.

The mixing operations in steps b) and c) may be carried out by any technique known to a person skilled in the art, in particular by mechanical mixing. The duration of mixing in step b) is of the order of 1 to 5 minutes and is easily determined by a person skilled in the art. The duration of mixing in step c) is of the order of one minute.

Step d) is carried out under time and temperature conditions determined by previously conducting experiments conventionally applied for optimizing the cross-linking of a thermosetting polymer (differential scanning calorimetry (DSC), steady-state or oscillating rheometry, dielectric techniques, etc.).

The cross-linking agent and CRₓ may be in solid or liquid form. When the cross-linking agent and/or CRₓ are in solid form, it is preferable to preheat each constituent of the formulation separately at a temperature that allows melting of all the compounds. This precaution guarantees homogeneity of the future mixture. Once this temperature is reached, the CRₓ may be added to the oil, followed by the cross-linking agent in accordance with steps b) to d) described above.

With the process of the invention, the savings in terms of temperature and/or time required for the cross-linking operation are very large relative to the processes currently used. Thus, the resin can be hardened in less than 10 minutes at 80° C., advantageously in less than 5 minutes.

In another embodiment of the invention, the process may also be carried out in the presence of a catalyst if this proves necessary. In this case the catalysts are those usually employed with epoxy formulations, for example tertiary amines, imidazoles etc.

The resins according to the invention, produced by the mixture of epoxidized oil(s) with a hardener and the reagent(s) (CRₓ) display a very clearly increased reactivity. Moreover, the material modified after cross-linking is endowed with very clearly improved thermomechanical properties.

When working with epoxidized vegetable oils, it is important to make clear that the addition of the reagent CRₓ to the initial formulation is carried out while keeping constant the ratio of the number of the epoxy groups to that of the reactive units of the hardener (anhydride, diacid, polyamine etc.) between the binary formulation (oil/hardener) and the ternary formulation (oil/hardener+CRₓ). CRₓ is then considered as a co-reactant. The co-reactant molecules are capable of reacting rapidly with the same hardener as that which allows the cross-linking of the epoxidized vegetable oil. As the latter is dosed so as to be able to consume all of the epoxy functions of the oil and of the co-reactant, the macromolecular network is continuous. Because of the reduced size of the co-reactant, the average unit cell of this network is smaller than that characteristic of the network obtained by the single reaction of the epoxidized vegetable oil with the hardener. The thermomechanical properties are then better with the co-reactant (mechanical rigidity and increased Tg). In fact, the additional reactivity and the thermal and mechanical performances depend on the intrinsic nature of the co-reactant and its relative dosage in the general formulation.

The epoxide resins according to the invention can be used in composite parts for mechanical construction or for building and in structural parts for construction, transport, aerospace, water sports, sports and leisure, in particular for applications involving structural parts exposed to fatigue or parts subjected to thermal variations.

They can also be used such as adhesives, preferably as structural adhesives or as surface coatings.

The invention is illustrated by FIGS. 1 to 7 and by Examples 1 to 5 which follow.

FIG. 1 illustrates the cross-linking reaction of an epoxidized oil with a diamine such as is known from the prior art. B1 is a central backbone of aliphatic or aromatic type.

FIG. 2 illustrates the standard reaction diagram of an epoxidized oil and an acid anhydride as known from the prior art. B2 represents a chemical block of aliphatic or aromatic type supporting the anhydride function.

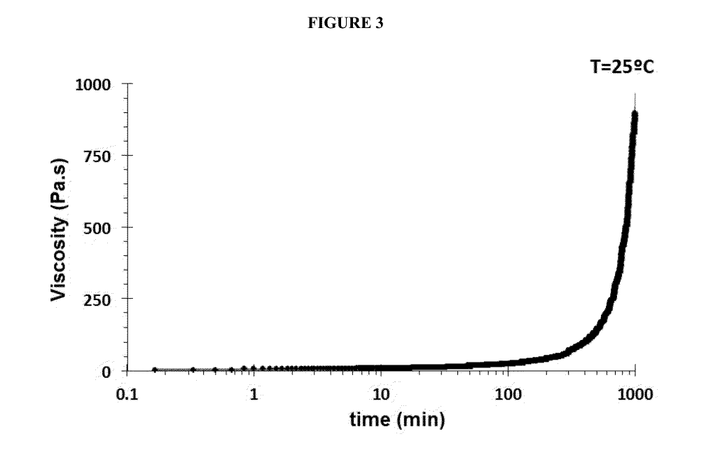

FIG. 3 illustrates the kinetic viscosimetric study of a binary formulation formed by a reagent of Formula 1b, 4,4′-methylene bis(N,N-diglycidylaniline) denoted CR1 with the methyltetrahydrophthalic anhydride (MTHPA) according to Example 1. The ratio of the number of acid anhydride groups to the number of epoxy groups is equal to 1.

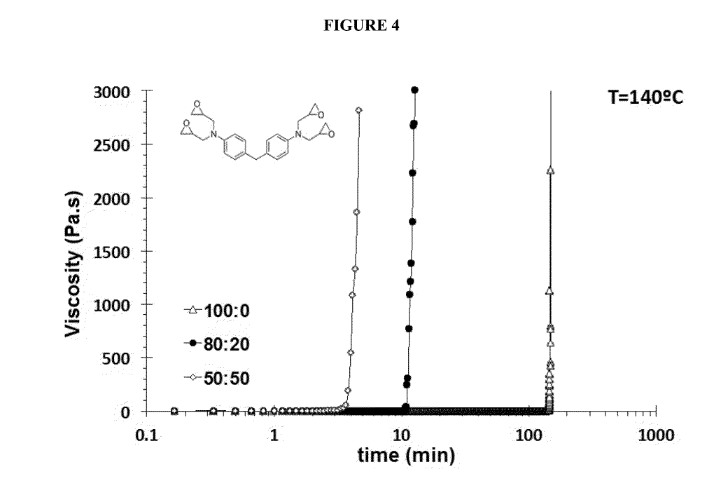

FIG. 4 illustrates the effect produced by the addition of—4,4′-methylene bis(N,N-diglycidylaniline) denoted CR1—on the gel time of formulations based on epoxidized linseed oil (ELO) and isophorone diamine (IPDA). Three kinetic viscosimetric readings at 140° C. are thus represented. The first (Δ) is characteristic of a mixture comprising 1 mole of epoxidized linseed oil to 1.5 moles of isophorone diamine (ELO-IPDA). The second () is characteristic of a mixture according to the invention comprising a mixture of epoxidized linseed oil and CR1 in a proportion of 80/20 (80% of the number of the epoxy groups are provided by the Oil ELO and 20% by CR1) with isophorone diamine (IPDA), keeping the ratio of the number of N—H groups to the number of epoxy functions equal to that of the preceding case (i.e. equal to 1). The last viscosimetric curve (⋄) is specific to a mixture according to the invention comprising a mixture of epoxidized linseed oil and CR1 in a proportion of 50/50 (50% of the number of epoxy groups are provided by the Oil ELO and 50% by CR1) with isophorone diamine (IPDA), keeping the ratio of the number of N—H groups to the number of epoxy functions equal to that of the preceding case (i.e. equal to 1).

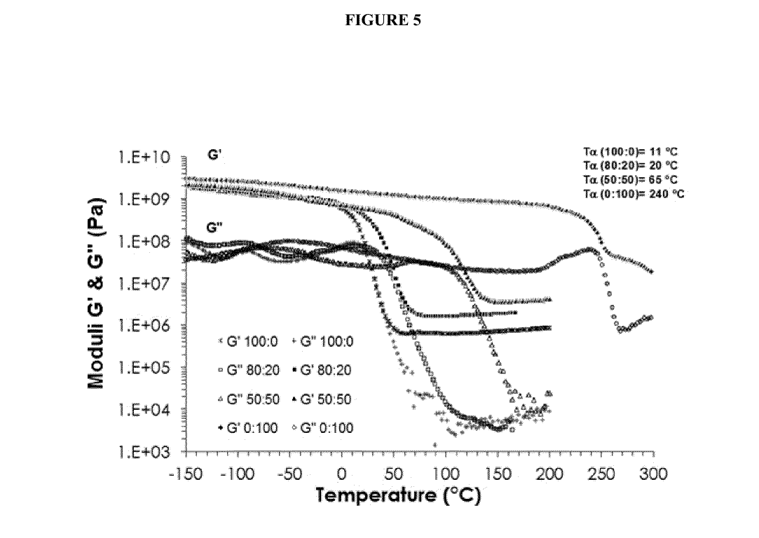

FIG. 5 illustrates the thermomechanical performances of mixtures according to the invention. The hardener is isophorone diamine (IPDA). The curves show the evolution of the viscoelastic components of various formulations according to the invention. Component G′ is called “storage modulus”; it translates the energy stored and then returned by the material and illustrates its mechanical rigidity. Component G″ denotes the “loss modulus” characteristic of the mechanical energy dissipated owing to the molecular motion taking place within the material. The principal relaxation of the polymer, associated with the rheological manifestation of the glass transition of the macromolecular network, is detected by the inflection of curve G′ (=sudden drop in mechanical rigidity). This phenomenon is accompanied by the formation of a main peak on the curve of G″. Its maximum makes it possible to estimate Tα of the material, in other words its glass transition temperature in the rheological meaning. Just one is detected by mixing, demonstrating the existence of a single macromolecular network; (100:0) represents a mixture of the state of the art, in which all the epoxy groups are provided by ELO. In other words, the mixture does not contain CR1; (80:20) represents a mixture in which the epoxy groups are provided at 80% of the total number by ELO, the remaining 20% being provided by CR1; (50:50) represents a mixture in which the epoxy groups are provided in equal proportion by ELO and CR1; (20:80) represents a mixture in which the epoxy groups are provided at 20% of the total number by ELO, the remaining 80% being provided by CR1; (0:100) represents a mixture in which the epoxy groups are provided at 100% by CR1.

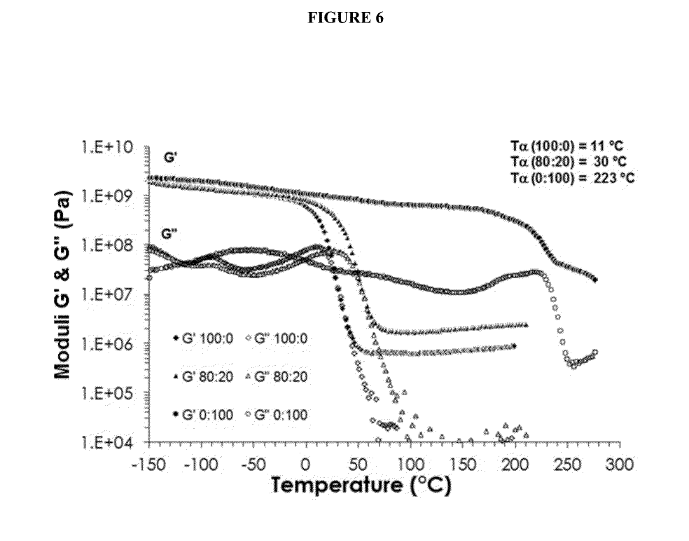

FIG. 6 illustrates the thermomechanical performances of mixtures according to the invention. The hardener is isophorone diamine (IPDA) and the reagent is a reagent of Formula 1b, N,N-diglycidyl-4-glycidyloxyaniline, (also called CR2). (100:0) represents a mixture according to the state of the art in which the all of the epoxy groups are provided by ELO. This mixture does not contain CR2; (80:20) represents a mixture in which the epoxy groups are provided at 80% of the total number by ELO, the remaining 20% being provided by CR2; (0:100) represents a mixture in which the epoxy groups are provided at 100% by CR2. In other words, this latter mixture does not contain epoxidized linseed oil.

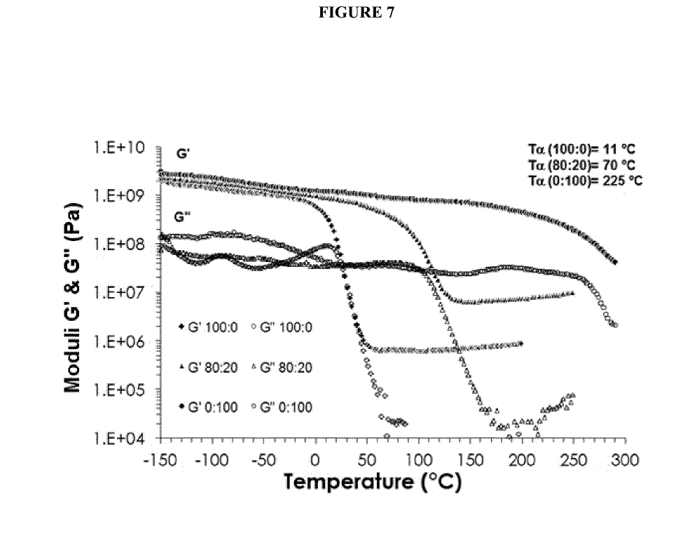

FIG. 7 illustrates the thermomechanical performances of mixtures according to the invention. The hardener is isophorone diamine (IPDA) and the reagent is another reagent of Formula 1a, triphenylolmethane triglycidyl ether (denoted by the term CR3). (100:0) represents a mixture of the state of the art in which all of the epoxy groups are provided by ELO. This mixture does not contain CR3; (80:20) represents a mixture in which the epoxy groups are provided at 80% of the number total by ELO, the remaining 20% being provided by CR3; (0:100) represents a mixture in which the epoxy groups are provided at 100% by CR3.

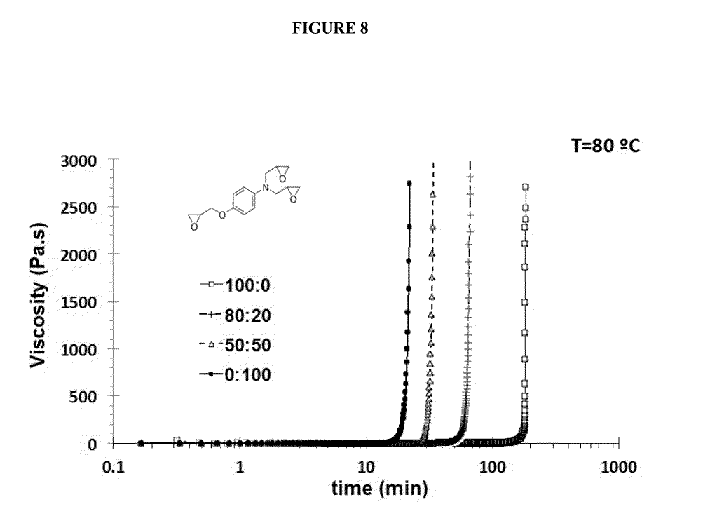

FIG. 8 illustrates the gel time of different formulations according to the invention. The hardener used is methyl tetrahydrophthalic anhydride (MTHPA); (100:0) represents a mixture according to the state of the art in which all of the epoxy groups are provided by ELO; (80:20) represents a mixture in which the epoxy groups are provided at 80% of the total number by ELO, the remaining 20% being provided by CR2; (50:50) represents a mixture in which the epoxy groups are provided in equal proportions by ELO and CR2; (0:100) represents a mixture in which the epoxy groups are provided at 100% by CR2.

### EXAMPLE 1

### Formulation of the Mixture of 4,4′-Methylene Bis(N,N-Diglycidylaniline) with Methyl Tetrahydrophthalic Anhydride (MTHPA) and the Resin Obtained

1.1. Preparation of the Mixture
a. MTHPA and 4,4′-methylenebis(N,N-diglycidylaniline) (or CR1) are liquid at ambient temperature. No pre-heating of the two materials is therefore necessary before the actual mixing operation.
b. MTHPA is then added to 4,4′-methylenebis(N,N-diglycidylaniline) in order to form the CR1-MTHPA mixture defined advantageously by a molar ratio of 1:4. In this specific case, the number of epoxy functions to the number of anhydride groups is then equal to 1.
c. A catalyst, 2-methyl imidazole, is dissolved in ethanol in order to produce a solution concentrated to 33% by mass. This solution is then added to the CR1-MTHPA mixture. The quantity of catalytic solution added represents 3% of the mass of the CR1-MTHPA mixture.
d. This mixture is then mixed for one minute so as to guarantee its homogeneity.
e. The cross-linking is carried out from 25° C.

1.2. Measurement of the Gel Time
The cross-linking reaction of a thermosetting formulation consists of producing a three-dimensional macromolecular network from the combination of reactive units. On the macroscopic scale, this conversion can be followed by the technique of steady-state viscosimetry. The experiment consists of recording the evolution of the viscosity of the mixture at constant temperature (that selected for cross-linking) by means of a rotary rheometer equipped for example with “parallel plate” geometry. The gel point associated with the critical formation of the macromolecular network is then defined by the time at which the viscosity of the mixture diverges. In practice, this time is detected by taking the point of intersection of the asymptote to the viscosity curve in the region of divergence with the time axis.

1.3. Results
They are presented in FIG. 3.
FIG. 3 shows that the viscosity of the CR1-MTHPA formulation very clearly evolves with time and diverges even for a duration close to 1000 minutes. This evolution demonstrates that the 4,4′-methylenebis(N,N-diglycidylaniline)—or CR1—is capable of directly reacting with the anhydride MTHPA. Thus, when it is added to “vegetable oil/hardener” binary mixtures, the CR1 acts as an epoxidized co-reactant. It must not be confused with a simple catalyst or initiator as it participates in the formation of the macromolecular network, itself reacting directly with the units of hardener.

### EXAMPLE 2

### Formulation Produced by the Mixture of Epoxidized Linseed Oil, 4,4′-Methylene Bis(N,N-Diglycidylaniline) (=CR1), and Isophorone Diamine (IPDA): Influence of the CR1 Content on the Gel Time of the Reactive Formulation and on the Thermomechanical Response of the Cross-Linked Material

2.1. Preparation of the Formulation
a. The ELO-IPDA binary mixture is prepared by pouring the liquid diamine into the oil at ambient temperature. In this example, the molar stoichiometry of the ELO-IPDA mixture is 1:1.5 i.e. an (N—H/epoxy) ratio=1.
b. In order to obtain the ELO-CR1-IPDA ternary formulation, the oil ELO and CR1 are firstly mixed at ambient temperature. The mixing is carried out for 5 minutes. Then, the hardener IPDA is incorporated in turn into this mixture. The mixing is continued for close to two minutes while the temperature is maintained at ambient temperature.
c. The stoichiometry of the ELO-CR1-IPDA mixture is calculated so as to confer on the medium a ratio of the number of epoxy groups to the number of amine groups equal to that selected in the case of the ELO-IPDA binary mixture.
d. Four formulations are proposed by way of example but all have an (N—H/epoxy) ratio equal to 1. That referenced by the code 100:0 corresponds to a binary formulation where 100% of the epoxy groups are provided by the oil ELO: therefore there is no CR1. The composition by mass of this formulation is 79.2% of ELO and 20.8% of IPDA. The second mixture is ternary and is referenced by the code 80:20 for which 80% of the epoxy groups are borne by the oil and 20% by CR1. The composition by mass of this formulation is 67.1% of ELO, 10.9% of CR1 and 22.0% of IPDA. As for the formulation 50:50 it represents a ternary mixture for which 50% of the epoxy groups are borne by the oil ELO and 50% by CR1. The composition by mass of this formulation is 46.0% of ELO, 29.9% of CR1 and 24.1% of IPDA. The last formulation is binary and is referenced by the code 0:100. It denotes a mixture in which 100% of the epoxy groups are provided by CR1: therefore there is no oil ELO. The composition by mass of this formulation is 0% of ELO, 71.3% of CR1 and 28.7% of IPDA.
e. Each formulation is cross-linked at 140° C. for 24 hours.

2.2. Results
The influence of the composition of the mixture on the gel time of the formulation is described by FIG. 4. The chemical structure of CR1 is shown in the same figure.
It should be noted that the substitution of the epoxidized lipid units by the epoxidized units of CR1 allows a very large reduction in the gel time. In fact, this latter is:
   147 min for a 100% ELO: 0% CR1-IPDA mixture,
   11 min for an 80% ELO: 20% CR1-IPDA mixture,
   4 min for a 50% ELO: 50% CR1-IPDA mixture,
The use of CR1 therefore leads to a very large reduction in the gel time of the formulation and therefore makes it possible to overcome the low reactivity of the epoxidized oils.
The effects of the composition of the mixture on the thermomechanical behaviour of the final material after cross-linking are described by FIG. 5.
The increase in the proportion of CR1 in the ELO-CR1-IPDA formulation leads to an increase in the thermomechanical performances of the material after cross-linking. This evolution is demonstrated by the increase in the glass transition temperature of the final product. It is induced by the more reduced size of the molecular segments of CR1 which causes an increase in the rigidity of the polymer network. At the same time a reduction is observed in the size and the average mass Mc of the unit cell of the network. This evolution is reflected in the increase in the value of the modulus G′ in the rubbery zone, since G′=f(1/Mc).

### EXAMPLE 3

### Formulation Produced by the Mixture of Epoxidized Linseed Oil, N,N-Diglycidyl-4-Glycidyloxyanillne (=CR2), and Isophorone Diamine: Influence of the CR2 Content on the Thermomechanical Performances of the Final Material

3.1. Preparation of the Formulation
a. Its method is similar to that described in Example 2: the ELO-IPDA binary mixture is prepared by pouring the liquid diamine into the oil at ambient temperature. In this example, the molar stoichiometry of the ELO-IPDA mixture is 1:1.5 i.e. an (N—H/epoxy) ratio=1.
b. The preparation of the ELO-CR2-IPDA ternary formulations firstly requires mixing the oil ELO and CR2 at ambient temperature. The mixing is carried out for 5 minutes. Then, the hardener IPDA is incorporated in turn into this mixture and the mixing is continued for close to two minutes at ambient temperature.
c. The stoichiometry of the ELO-CR2-IPDA mixture is calculated so as to confer on the medium a ratio of the number of epoxy groups to the number of amine groups equal to that selected in the case of the ELO-IPDA binary mixture.
d. Three formulations are thus proposed in order to illustrate this Example 3. All have an (N—H/epoxy) ratio equal to 1. Two are binary. The first referenced by the code 100:0 corresponds to a formulation where 100% of the epoxy groups are provided by the oil ELO: therefore there is no CR2. Its composition by mass is 79.2% of ELO and 20.8% of IPDA. The second binary mixture, referenced by the code 0:100, denotes a mixture in which 100% of the epoxy groups are provided by CR2. The composition by mass of this formulation is 0% of ELO, 68.4% of CR2 and 31.6% of IPDA. The third formulation is ternary and is referenced by the code 80:20. It corresponds to a mixture where 80% of the epoxy groups are borne by the oil and 20% by CR2. Its composition by mass is 68.0% of ELO, 9.7% of CR2 and 22.3% of IPDA.
e. Each formulation is cross-linked at 140° C. for 24 hours.

3.2. Results
The influence of the CR2 content on the thermomechanical performances of the material after cross-linking is described by FIG. 6.
The trends identified previously with CR1 are again encountered with the other co-reactant CR2. In particular, the increase in the proportion of co-reactant in the ELO-CR2-IPDA formulation leads to an increase in the glass transition temperature of the material after cross-linking. The increase in the value of the modulus G′=f(1/Mc) in the rubbery zone again reflects a reduction in the size and the average mass Mc of the unit cell of the network.

### EXAMPLE 4

### Formulation Produced by the Mixture of Epoxidized Linseed Oil, Triphenylolmethane Triglycidyl Ether (=Co-Reactant CR3), and Isophorone Diamine: Evolution of the Thermomechanical Performances of the Final Material with the CR3 Content

4.1. Preparation of the Formulation
a. The ELO-IPDA binary mixture is prepared by pouring the liquid diamine into the oil at ambient temperature. The molar stoichiometry of the ELO-IPDA mixture is 1:1.5 i.e. an (N—H/epoxy) ratio=1.
b. The preparation of the ELO-CR3-IPDA ternary formulations requires mixing of the oil ELO and CR3 beforehand at 60° C. This last temperature is necessary in order to induce melting of the solid CR3 at ambient temperature. The mixing is carried out for 5 minutes. Then, the hardener IPDA is incorporated in turn into this mixture in order to produce the ternary formulation. The mixing is continued for one minute at 60° C.
c. The stoichiometry of the ELO-CR3-IPDA mixture is calculated so as to confer on the medium a ratio of the number of epoxy groups to the number of amine groups equal to that selected in the case of the ELO-IPDA binary mixture. In other words, all the formulations have an (N—H/epoxy) ratio equal to 1.
d. Three formulations are thus proposed in order to illustrate this Example 4. Two are binary. The first denoted by the code 100:0 corresponds to a formulation where 100% of the epoxy groups are provided by the oil ELO Its composition by mass is 79.2% of ELO and 20.8% of IPDA. The second binary mixture, referenced by the code 0:100, designates a mixture in which 100% of the epoxy groups are provided by CR3. The composition by mass of this formulation is 0% of ELO, 78.3% of CR3 and 21.7% of IPDA. The last formulation is referenced by the code 80:20. It corresponds to a ternary mixture where 80% of the epoxy groups are borne by the oil and 20% by CR3. Its composition by mass is 63.9% of ELO, 15.1% of CR3 and 21% of IPDA.
e. Each formulation is cross-linked at 140° C. for 24 hours.

4.2. Results
The effects products by the increase in the CR3 content on the thermomechanical performances of the material after cross-linking are illustrated by FIG. 7.
As in the preceding two cases, the increase in the proportion of CR3 in the ELO-CR3-IPDA formulation leads to an increase in the glass transition temperature of the material after cross-linking. However, in the present case, the evolution is even more apparent. The rubbery plateau modulus itself also increases revealing a reduction in the size and in the average mass Mc of the unit cell of the polymer network.

### EXAMPLE 5

### Formulation Produced by the Mixture of Epoxidized Linseed Oil (ELO), N,N-Diglycidyl-4-Glycidyloxyaniline (=CR2) and Methyl Tetrahydrophthalic Anhydride (MTHPA) in the Presence of 2-Methyl Imidazole (2MI) as Catalyst: Influence on the Gel Time of the Reactive Formulation and Evolution of the Thermomechanical Performances of the Final Material with the CR2 Content

5.1. Preparation of the ELO-MTHPA-2MI Ternary Formulation
a. The ELO-MTHPA-2MI ternary mixture is prepared by pouring the anhydride into the oil at ambient temperature. The molar stoichiometry of the ELO-MTHPA mixture is 1:6 i.e. an (epoxy/anhydride) ratio=6.
b. Then, the 2-methyl imidazole (2MI) catalyst in ethanolic solution (concentration by mass=33%) is added to the preceding mixture. The quantity of ethanolic solution added represents a few percent of the mass of the ELO-MTHPA mixture (advantageously close to 3%).
c. The mixture is mixed at ambient temperature for 2 minutes.
d. The proportions by mass of ELO, MTHPA and 2MI are respectively of the order of 53.4%, 43.7% and 2.9%. It is denoted by the code 100:0 in order to illustrate the absence of CR2.
e. The cross-linking of the formulation is carried out at 140° C. for 24 hours.

5.2. Preparation of the CR2-MTHPA-2MI Ternary Formulation
a. The CR2-MTHPA-2MI ternary mixture is prepared by pouring the anhydride into CR2 at ambient temperature. The molar stoichiometry of the CR2-MTHPA mixture is 1:3 i.e. an (epoxy/anhydride) ratio=3.
b. Then, the 2-methyl imidazole (2MI) catalyst in ethanolic solution (concentration by mass=33%) is added to the preceding mixture. The quantity of ethanolic solution added represents a few percent of the mass of the CR2-MTHPA mixture (advantageously close to 3%).
c. The mixture is mixed at ambient temperature for 2 minutes.
d. The proportions by mass of CR2, MTHPA and 2MI are respectively of the order of 39.4%, 56.8% and 3.8%. It is denoted by the code 0:100 in order to illustrate the absence of epoxidized oil.
e. The cross-linking of the formulation is carried out at 140° C. for 24 hours.

5.3. Preparation of the ELO-CR2-MTHPA-2MI Quaternary Formulation
a. CR2 is poured into the oil at ambient temperature.
b. The mixture is mixed for 2 minutes at ambient temperature.
c. The liquid anhydride and the catalyst in ethanolic solution (33% m/m) are then added to the preceding mixture. The anhydride is dosed so as to ensure an “acid anhydride groups/epoxy groups” ratio equal to 1. The quantity of catalytic solution advantageously represents 3% of the mass of the ELO-CR2-MTHPA mixture.
d. This ELO-CR2-MTHPA-2MI mixture is then mixed for 3 minutes at ambient temperature.
e. Two formulations were prepared in this category in order to illustrate Example 6. That denoted by the code 80:20 corresponds to a quaternary mixture where 80% of the epoxy groups are borne by the oil and 20% by CR2. Its composition by mass is 44.8% of ELO, 6.4% of CR2, 45.8% of MTHPA and 3.1% of 2MI. That referenced by the code 50:50 corresponds to a quaternary mixture where 50% of the epoxy groups are borne by the oil and 50% by CR2. Its composition by mass is 30.2% of ELO, 17.2% of CR2, 49.4% of MTHPA and 3.3% of 2MI.
f. The cross-linking of each of these formulations was carried out at 140° C. for 24 hours.

5.4. Results
They are presented in FIG. 8. The chemical structure of CR2 is shown in the same figure.
This latter demonstrates the benefit of adding CR2 to the formulation initially based on the mixture of epoxidized linseed oil ELO, MTHPA and 2-methyl-imidazole catalyst. In fact, at 80° C., the gel time of the ELO-MTHPA-2MI formulation (100:0) is close to 180 minutes. However, the addition of CR2 allows this critical time to be significantly reduced.
   Thus, for the formulation within which 80% of the epoxy groups are borne by the oil ELO and 20% by CR2, the gel time is 60 minutes.
   In the formulation 50:50 where the epoxy groups are equally distributed between the oil ELO and CR2, the gel time is further reduced as it is no more than 30 minutes.
   Finally, viscosimetric analysis of the CR2-MTHPA (0-100) formulation demonstrates that N,N-diglycidyl-4-glycidyloxyaniline —or CR2—is capable of reacting alone with the anhydride MTHPA. The gel time of the formulation at 80° C. is then 20 minutes.
These data show that the CR2 is not a simple catalyst: it directly participates in the formation of the macromolecular network, by itself reacting with the units of hardener of anhydride type.
All of these results show that the reagents of formula (Ia) and (Ib) are not simple catalysts but directly participate in the formation of the macromolecular network, by themselves reacting with the units of hardener used.

1. An epoxide resin comprising the product of the reaction of a mixture comprising:
at least
one non-biosourced non-polymer reagent bearing at least 3 epoxy end functions (CRₓ);
at least one biosourced epoxidized lipid derivative; and
at least one cross-linking agent;
a ratio between the number of reactive functions of the cross-linking agent and the number of epoxy functions being kept constant independently of the constitution of the mixture, on the condition that:
CRₓ is not a compound having the following formula (a): 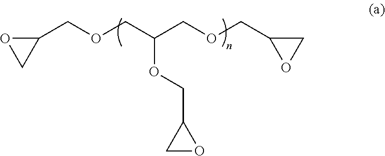
in which n is an integer comprised between 1 and 20.

2. The epoxide resin according to claim 1 characterized in that the at least one co-reactant corresponds
a. to the formula (Ia), 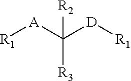
(Ia)
in which
A and D each represent independently of one another:
a —(CₙH₂ₙ)— radical where n is comprised between 1 and 5; in particular a —CH₂— radical or
an arylene radical, in particular a phenylene radical (—C₆H₄—); or
a —(CH₂)ₗ—O—(CH₂)ₘ—[CH(CH₃)]ₚ—OR group where l and m, identical or different, are integers comprised between 1 and 5, therefore being able to equal, independently of one another, to 0, 1, 2, 3, 4 or 5, p is an integer comprised between 0 and 1, and R is the following group 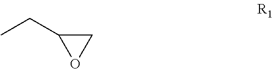
represents an —OR group, where R is as defined previously
R₂ and R₃ each represent independently of one another,
either a hydrogen atom,
or a linear or branched (C₁-C₅)alkyl group,
or an —OR group, where R is as defined previously,
or a —CH₂OR group, where R is as defined previously,
or a —C₆H₄OR group, where R is as defined previously,
or an —O—(CH₂)ᵣ—[CH(CH₃)]ₛ—OR group, where p is an integer comprised between 1 and 5, advantageously equal to 1, 2, 3, 4 or 5 and q is an integer comprised between 0 and 1 and R is as defined previously,
on the condition that the compound of formula 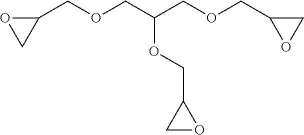 [SMILES: C(OCC1CO1)C(COCC1CO1)OCC1CO1]
is excluded,
or
b. to the formula (Ib) 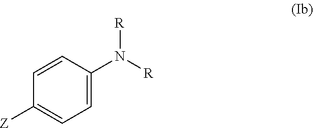
in which
Z represents
either an OR group where R is as defined previously,
or the following group 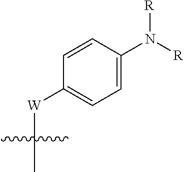
where W is selected from the group comprising the oxygen and sulphur atoms and the linear or branched —(CₙH₂ₙ)— radicals where n is comprised between 1 and 5, therefore being able to be equal to 1, 2, 3, 4 or 5 and —SO₂— and R is as defined previously.

3. The epoxide resin according to claim 2 characterized in that the at least one CRₓ corresponds to formula (Ia) in which:
A and D each represent a —CH₂— group,
R₂ represents either a hydrogen atom, or a —CH₂OR group, or a —C₆H₄OR group where R is as defined previously, R₃ represents a methyl, ethyl, —CH₂OR or —O—CH₂—CH(CH₃)—OR group where R is as defined previously.

4. The epoxide resin according to claim 2 characterized in that the at least one CRₓ corresponds to formula (Ia) in which:
A and D each represent a —(C₆H₄)— group,
R₂ represents a hydrogen atom or a methyl group and
R₃ represents a —C₆H₄OR group where R is as defined previously.

5. The epoxide resin according to claim 1, characterized in that the one or more biosourced epoxidized lipid derivatives are extracts of a natural vegetable oil, in particular vernolia oil, in which they are present in the epoxidized form.

6. The epoxide resin according to claim 1, characterized in that the epoxidized lipid derivative(s) are obtained by epoxidation of lipids extracted from natural vegetable oils selected from the group comprising linseed oil, hemp oil, sunflower oil, colza oil, soya oil, olive oil, grapeseed oil, tung wood oil, cotton oil, maize oil, hazelnut oil, coconut oil, palm oil, castor oil, cashew nut oil and peanut oil and a mixture of the latter or animal oil extracts.

7. The epoxide resin according to claim 1 characterized in that the at least one cross-linking agent is selected:
a. from the group comprising compounds bearing amine functions, said compounds when they are bearing primary amine functions being selected from the group comprising the diamines, polyamines and mixtures thereof or
b. from the group of the acid anhydrides or
c. from the group of the diacids and the polyacids or
d. from the group of the alcohols including the phenols or
e. from the group of the polymercaptans or
f. from the group comprising the mixtures of at least two agents chosen from those mentioned in a) to e).

8. The epoxide resin according to claim 7 characterized in that, when the at least one cross-linking agent is a compound bearing N—H groups, belonging to the primary or secondary amine functions, the ratio of the number of N—H groups to the number of epoxy groups is equal to unity.

9. The epoxide resin according to claim 7 characterized in that, when the at least one cross-linking agent is an acid anhydride, the ratio of the number of acid anhydride groups to the number of epoxy groups is equal to unity.

10. A process for the formulation of epoxide resins comprising the mixture of:
at least one non-biosourced non-polymer reagent bearing at least 3 epoxy end functions (CRₓ);
at least one biosourced epoxidized lipid derivative; and
at least one cross-linking agent;
the ratio between the number of reactive functions of the cross-linking agent and the number of epoxy functions being kept constant independently of the constitution of the mixture, on the condition that:
said non-biosourced, non-polymer reagent is not a compound having the following formula (a): 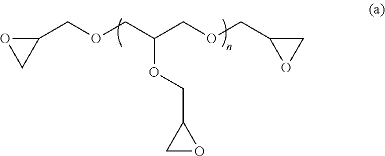
in which n is an integer comprised between 1 and 20.

11. The process for the preparation of epoxide resins according to claim 10 characterized in that it comprises the following steps:
a. mixing one or more biosourced epoxidized lipid derivatives;
b. adding the co-reactant then carrying out a mixing operation to obtain a homogeneous epoxy mixture; and
c. adding the cross-linking agent to said mixture then carrying out a further mixing operation, then leaving the resin to react-.

12. Use of epoxide resins according to claim 1 in composite parts for mechanical construction or for building and in structural parts for construction, transport, aerospace, water sports, sports and leisure.

13. The use of epoxide resins according to claim 12, characterized in that the applications in question involve structural parts exposed to fatigue or parts subjected to thermal variations.

14. Use of epoxide resins according to claim 1 as adhesives, preferably as structural adhesive s or as surface coatings.
